(19) United States
(12) Patent Application Publication
(10) Pub. No.: US 2005/0075025 A1
(43) Pub. Date: Apr. 7, 2005

(54) Carpet for vehicles and method for manufacturing the same

(76) Inventors: Tetsuya Ueda, Osaka (JP); Yoshihiko Hata, Kokagun (JP); Hideo Hayashi, Kokagun (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/443,123

(22) Filed: May 22, 2003

(30) Foreign Application Priority Data
May 24, 2002 (JP) 2002-151096

(51) Int. Cl. B32B 27/04; B32B 5/02

(52) U.S. Cl. 442/149; 428/85

(57) ABSTRACT

A carpet for use in vehicles includes an upper surface layer 2, a nonwoven fabric sound absorption layer 3 and an adhesive resin layer 4 integrally securing the upper surface layer and the sound absorption layer. The adhesive resin layer is an air permeable resin layer formed by extruding melted thermoplastic into filament-like resin pieces by an extruder, and a thickness direction air permeability of the carpet falls within the range of 1 to 50 cm³/cm²·second. This carpet can secure excellent silence.

Priority is claimed to Japanese Patent Application No. 2002-151096, filed on May 24, 2002, the disclosure of which is incorporated by reference in its entirety.

### BACKGROUND OF THE INVENTION

1. Field of the Invention

The present invention relates to a carpet for use in vehicles, such as a floor carpet for automobiles, which is excellent in air permeability and capable of absorbing vibration/noise entering into an inside space of a vehicle from an outside of the vehicle and noise generated in the inside space of the vehicle to thereby secure a comfortable vehicle inside space with sufficient quietness, and also relates to a method for manufacturing the carpet.

In this specification, the wording “air permeability” means an air permeability measured in accordance with the method according to 8.27.1 A of JIS (Japanese Industrial Standard) L 1096-1999.

2. Prior Art

Conventionally, a floor carpet or a mat is disposed on an automobile floor for the purpose of obtaining a good step feeling and preventing vibration of the automobile floor and noise entering from an outside into an inside space of the automobile and preventing a direct contact of a passenger's body with metal plates constituting the automobile floor.

According to conventional technique for preventing these vibration, and noise, an airtight weight layer made of thermoplastic resin is provided under an upper surface layer as a noise insulating layer to prevent vibration and noise. Furthermore, in view of the recent strong demand for energy saving and weight saving, as a carpet for automobiles capable of obtaining noise absorbing performance in addition to noise insulating performance while keeping the weight saving, it is also known that a noise absorbing layer made of nonwoven fabric is integrally formed on the lower side of a carpet upper surface layer via an adhesive film.

Now, external noise entering into an inside space of an automobile comes from many noise sources such as an automobile engine, a gear box and its auxiliary unit, an exhaust system, an air or tires. Therefore, only if all of these noise and vibration are effectively prevented, quietness of an inside space of an automobile can be attained. According to the aforementioned conventional technique, however, although the noise insulating layer and the noise absorbing layer were effective against noise/vibration from an underside of an automobile floor, they were not so effective to the noise from a roof, doors and/or windows of an automobile.

### SUMMARY OF THE INVENTION

The present invention was conceived in view of the aforementioned technical background, and aims to provide a carpet for use in vehicles capable of attaining quietness of an inside of an automobile by effectively absorbing noise entering into the inside of the vehicle via a roof, doors and windows of the vehicle as well as the noise/vibration entering from the underside of a floor of the vehicle, and also to provide a method for manufacturing the carpet.

In order to solve the aforementioned objects, the inventors diligently conducted studies, and found the fact that, in a carpet for use in vehicles in which an upper surface layer and a noise absorbing layer are integrally connected via an adhesive resin layer, it is possible to obtain a carpet for use in vehicles capable of attaining quietness of an inside of a vehicle by effectively absorbing noise by employing an air permeable resin layer formed by extruding melted thermoplastic resin into filament-like resin pieces as an adhesive resin layer and setting a thickness direction air permeability of the carpet so as to fall within a predetermined range. Thus, the present invention has been completed.

That is, in order to attain the aforementioned object, the present invention provides the following means.

(1) A carpet for use in vehicles, comprising an upper surface layer, a sound absorption layer made of nonwoven fabric and an adhesive resin layer integrally securing the upper surface layer and the sound absorption layer, wherein the adhesive resin layer is an air permeable resin layer formed by extruding melted thermoplastic resin into filament-like resin pieces by an extruder, and wherein a thickness direction air permeability of the carpet falls within the range of 1 to 50 cm³/cm²·second.

(2) The carpet for use in vehicles according to the aforementioned Item (1), wherein the thickness direction air permeability of the carpet is 10 to 45 cm³/cm²·second.

(3) The carpet for use in vehicles according to the aforementioned Item (1), wherein the thickness direction air permeability of the carpet is 25 to 40 cm³/cm²·second.

(4) The carpet for use in vehicles according to the aforementioned Item (1), wherein a thickness of the sound absorption layer is 1 to 15 mm.

(5) The carpet for use in vehicles according to the aforementioned Item (1), wherein an apparent density of the sound absorption layer is 0.01 to 0.5 g/cm³.

(6) The carpet for use in vehicles according to the aforementioned Item (1), wherein a fineness of the filament-like resin piece constituting the sound absorption layer falls within the range of 0.1 to 30 dtex.

(7) The carpet for use in vehicles according to the aforementioned Item (1), wherein a fineness of the filament-like resin piece constituting the sound absorption layer falls within the range of 0.1 to 15 dtex.

(8) The carpet for use in vehicles according to the aforementioned Item (1), wherein a thickness of the sound absorption layer is 1 to 15 mm, wherein an apparent density of the sound absorption layer is 0.01 to 0.5 g/cm³, and wherein a fineness of the filament-like resin piece constituting the sound absorption layer falls within the range of 0.1 to 30 dtex.

(9) The carpet for use in vehicles according to the aforementioned Item (1), wherein the thermoplastic resin constituting the adhesive-resin layer is polyolefin resin.

(10) The carpet for use in vehicles according to the aforementioned Item (1), wherein the thermoplastic resin constituting the adhesive resin layer is polyethylene.

(11) The carpet for use in vehicles according to the aforementioned Item (1), wherein a melt flow rate of the thermoplastic resin constituting the adhesive resin layer is 1 to 100.

(12) The carpet for use in vehicles according to the aforementioned Item (1), wherein a melt flow rate of the thermoplastic resin constituting the adhesive resin layer is 10 to 50.

(13) The carpet for use. in vehicles according to the aforementioned Item (1), wherein an adhered amount of the thermoplastic resin constituting the adhesive resin layer is 50 to 500 g/M².

(14) The carpet for use in vehicles according to the aforementioned Item (1), wherein an adhered amount of the thermoplastic resin constituting the adhesive resin layer is 100 to 300 g/m².

(15) The carpet for use in vehicles according to the aforementioned Item (1), wherein a melt flow rate of the thermoplastic resin constituting the adhesive resin layer is 1 to 100, and wherein an adhered amount of the thermoplastic resin constituting the adhesive resin layer is 50 to 500 g/m².

(16) The carpet for use in vehicles according to the aforementioned Item (1), wherein a melt flow rate of the thermoplastic resin constituting the adhesive resin layer is 10to 50, and wherein an adhered amount of the thermoplastic resin constituting the adhesive resin layer is 100 to 300 g/m².

(17) The carpet for use in vehicles according. to the aforementioned Item (1), wherein the thickness direction air permeability of the carpet is 10 to 45 cm³/cm²·second, wherein a thickness of the nonwoven sound absorption layer is 1 to 15 mm, wherein an apparent density of the sound absorption layer is 0.01 to 0.5 g/cm³, wherein a fineness of the filament-like resin piece constituting the sound absorption layer falls within the range of 0.1 to 15 dtex, wherein a melt flow rate of the thermoplastic resin constituting the adhesive resin layer is 1 to 100, and wherein an adhered amount of the thermoplastic resin constituting the adhesive resin layer is 50 to 500 g/m².

(18) The carpet for use in vehicles according to the aforementioned Item (1), wherein the carpet is a floor carpet for use in automobiles.

(19) A method for manufacturing a carpet for use in vehicles, the method comprising:

extruding melted thermoplastic resin into filament-like resin pieces by an extruder; and

integrally securing an upper surface material and a nonwoven fabric via an air permeable resin layer by superimposing the upper surface material and the nonwoven fabric via the filament-like resin pieces.

(20) A method for manufacturing a carpet for use in vehicles, the method comprising:

continuously extruding melted thermoplastic resin into filament-like resin pieces by an extruder; and

integrally securing an upper surface material and a nonwoven fabric via an air permeable resin layer by superimposing the upper surface material and the nonwoven fabric which are being supplied continuously via the filament-like resin pieces.

(21) The method for manufacturing a carpet for use in vehicles according to Item (20), wherein the melted thermoplastic resin is continuously extruded into filament-like resin pieces in a vertically downward direction or in an approximately vertically downward direction by the extruder.

(22) A method for manufacturing a carpet for use in vehicles, the method comprising:

continuously extruding melted thermoplastic resin into filament-like resin pieces in a vertically downward direction or in an approximately vertically downward direction by an extruder; and

integrally securing an upper surface material and a nonwoven fabric via an air permeable resin layer by superimposing the upper surface material and the nonwoven fabric immediately after supplying the filament-like resin pieces onto at least one of superimposing surfaces of the upper surface material and the nonwoven fabric which are being supplied continuously.

(23) The method for manufacturing a carpet for use in vehicles according to Item (19) or (22), wherein the upper surface material and the nonwoven fabric are superimposed while being pressurized.

(24) The method for manufacturing a carpet for use in vehicles according to Item (19) or (22), wherein the upper surface material and the nonwoven fabric are superimposed while being pressurized and cooled.

(25) The method for manufacturing a carpet for use in vehicles according to Item (23), wherein the pressurizing is performed by using cooling pressure rollers.

(26) The method for manufacturing a carpet for use in vehicles according to Item (25), wherein the cooling pressure rollers are of a water-cooling type.

(27) The method for manufacturing a carpet for use in, vehicles according to Item (19) or (22), wherein the extruder is a T-die type extruder.

(28) The method for manufacturing a carpet for use in vehicles according to Item (19) or (22), wherein a thickness of the extruded filament-like resin piece is 0.5 to 7 mm in diameter.

(29) The method for manufacturing a carpet for use in vehicles according to Item (19) or (22), wherein a displacement density of the extruded filament-like resin pieces is 5 to 200 pieces/10 cm (i.e., 5 to 200 pieces per 10 cm in a direction parallel to a widthwise direction of the upper surface material which is being continuously supplied).

(30) The method for manufacturing a carpet for use in vehicles according to Item (19) or (22), wherein a melt flow rate of the thermoplastic resin is 1 to 100, and wherein weight per unit area of the air permeable resin layer is 50 to 500 g/m².

(31) The method for manufacturing a carpet for use in vehicles according to the aforementioned Item (19) or (22), wherein a melt flow rate of the thermoplastic resin is 10 to 50, and wherein weight per unit area of the permeable thermoplastic resin is 100 to 300 g/m².

(32) The method for manufacturing a carpet for use in vehicles according to the aforementioned Item (22), wherein the filament-like resin pieces are applied while moving the filament-like resin pieces in a direction parallel to a widthwise direction of the upper surface material which is being continuously supplied, and wherein “in a direction parallel to a widthwise direction of the upper surface material which is being continuously supplied” denotes a depth direction in FIG. 3.

(33) The method for manufacturing a carpet for use in vehicles according to the aforementioned Item (32), wherein the filament-like resin pieces are moved in a direction parallel to a widthwise direction of the upper surface material which is being continuously supplied by moving the extruder in a direction parallel to the widthwise direction of the upper surface material which is being continuously supplied.

(34) The method for manufacturing a carpet for use in vehicles according to the aforementioned Item (32), wherein the filament-like resin pieces are moved in a direction parallel to a widthwise direction of the upper surface material which is being continuously supplied by applying an air flow to the filament-like resin pieces.

(35) The method for manufacturing a carpet for use in vehicles according to the aforementioned Item (22), wherein the filament-like resin pieces are applied to both of the superimposing surfaces of the upper surface material and the nonwoven fabric which are being supplied.

(36) A method for manufacturing a carpet for use in vehicles, the method comprising:

continuously extruding melted thermoplastic resin having melt flow rate of 1 to 100 into plural rows of filament-like resin pieces each having a thickness-(diameter) of 0.5 to 7 mm in a vertically downward direction or in an approximately vertically downward direction by a T-die type extruder; and

integrally securing an upper surface material and a nonwoven fabric via an air permeable resin layer by superimposing the upper surface material and the nonwoven fabric in a pressurized cooling state immediately after supplying the filament-like resin pieces at a supplying amount of 50 to 500 g/m² onto each of the superimposing surfaces of the upper surface material and the nonwoven fabric which are being supplied continuously while moving the filament-like resin pieces in a direction parallel to a widthwise direction of the upper surface material and the nonwoven fabric which are being supplied continuously.

(37) The method for manufacturing a carpet for use in vehicles according to the aforementioned Item (36), wherein a displacement density of the extruded filament-like resin pieces is 5 to 200 pieces/10 cm.

The carpet for use in vehicles according to the first invention comprises an upper surface layer, a sound absorption layer made of nonwoven fabric and an adhesive resin layer integrally securing the upper surface layer and the sound absorption layer, wherein the adhesive resin layer is an air permeable resin layer formed by extruding melted thermoplastic into filament-like resin pieces by an extruder, and wherein a thickness direction air permeability of the carpet falls within the range of 1 to 50 cm³ /cm²·second.

Since the nonwoven fabric sound absorption layer is disposed at the lower side of the carpet, an excellent sound absorption performance can be exhibited against the noise entering from the lower side. Furthermore, since the adhesive resin layer is formed by extruding the melted thermoplastic resin into filament-like resin pieces by an extruder and has an air permeability, the noise entered from an upper side of a vehicle, such as a roof, doors or windows, passes through this air permeable adhesive resin layer and then reaches the nonwoven fabric sound absorption layer to be absorbed therein. Since the thickness direction air permeability of the carpet is set to be 1 to 50 cm³/cm²·second, even in cases where the noise entering from the lower side is too large to assuredly absorb with the sound absorption layer, leakage of the noise entering into an inner space of a vehicle can be effectively prevented by the adhesive resin layer.

The thickness direction air permeability of the carpet is a value to be measured in a state in which the upper surface layer, the adhesive resin layer and the nonwoven fabric layer are integrally secured in a laminated manner.

In the carpet for use in vehicles, it is preferable that a thickness of the nonwoven sound absorption layer is 1 to 15 mm, an apparent density of the sound absorption layer is 0.01 to 0.5 g/cm³, and a fineness of the filament-like piece constituting the sound absorption layer falls within the range of 0.1 to 30 dtex. In general, it is said that tire noise and engine noise range in a low frequency zone, and wind sound and exhaust sound range in a high frequency zone. By employing the aforementioned structure, enough sound absorption performance can be exerted in a wide frequency range covering from a low frequency zone to a high frequency zone.

In the carpet for use in vehicles according to the present invention, it is preferable to use polyolefin resin as the thermoplastic resin constituting the adhesive resin layer. In this case, the adhesive strength can be further increased and the recycling efficiency can be improved.

It is preferable that the melt flow rate of the thermoplastic resin constituting the adhesive resin layer is 1 to 100 and that the applying amount of the thermoplastic resin is 50 to 500 g/m². It is more preferable that the melt flow rate of the thermoplastic resin is 10 to 50 and that the applying amount thereof is 100 to 300 g/m². If the melt flow rate is less than 1, it becomes difficult to evenly apply, and therefore it is not preferable. To the contrary, if the melt flow rate exceeds 100, the resin easily permeates the upper surface material and the sound absorption nonwoven fabric to thereby hardly form the adhesive resin layer, and therefore it is not preferable. As for the thickness and the number of the filament-like resin pieces formed by extruding melted resin into filament-like resin pieces with an extruder, it is preferable that the diameter is 0.5 to 7 mm, the number is 5 to 200 pieces/10 cm (i.e., 5 to 200 pieces per 10 cm in a direction parallel to a widthwise direction of the upper surface material which is being continuously supplied), and the number of aperture rows is 1 to 5 (in the embodiment shown in FIG. 3, five rows are employed).

The method for manufacturing a carpet for use in vehicles according to the second invention, the method comprises:

extruding melted thermoplastic resin into filament-like resin pieces by an extruder; and

integrally securing an upper surface material and a nonwoven fabric via an air permeable resin layer by superimposing the upper surface material and the nonwoven fabric via the filament-like resin pieces.

It is more preferable that the method comprises: continuously extruding melted thermoplastic resin into filament-like resin pieces in a vertically downward direction or in an approximately vertically downward direction by an extruder; and integrally securing an upper surface material and a nonwoven fabric via an air permeable resin layer by superimposing the upper surface material and the nonwoven fabric immediately after supplying the filament-like resin pieces onto at least one of superimposing surfaces of the upper surface material and the nonwoven fabric which are being supplied continuously. For example, immediately after applying the filament-like resin pieces, the upper surface material and the nonwoven fabric are pressed with nip rollers and cooled to thereby integrally secure them in a superimposed manner.

It is preferable that the thickness of the extruded filament-like resin piece is 0.5 to 7 mm in diameter and that the number of the extruded filament-like resin pieces is 5 to 200 pieces/10 cm (i.e., 5 to 200 pieces per 10 cm in a direction parallel to a widthwise direction of the upper surface material which is being continuously supplied).

Furthermore, it is preferable to use polyethylene resin as the thermoplastic resin constituting the adhesive resin layer from the viewpoint of adhesive strength and cost. Although the extruder is not limited to a specific one, it is preferable to use a T-die extruder since this extruder can stably extrude filament-like resin pieces in a wide range. Furthermore, it is preferable to apply the filament-like resin pieces in a zigzag manner or in a crossed manner rather than applying in a straight manner from the view point of obtaining stable permeability and carpet strength. Accordingly, it is preferable to apply the filament-like resin pieces while moving right and left (in a direction parallel to a widthwise direction of the skin surface material which is being supplied) by, for example, moving the extruder right and left or applying air flows against the filament-like adhesive resin pieces.

Other objects and features will be apparent from the below mentioned detail explanation of the invention with reference to the attached drawings.

### BRIEF DESCRIPTION OF THE DRAWINGS

FIG. 1 is a schematic cross-sectional view showing a carpet for use in vehicles according to one embodiment of the present invention.

FIG. 2 is a schematic cross-sectional view showing a carpet for use in vehicles according to another embodiment of the present invention.

FIG. 3 is a schematic view showing the manufacturing method according to the present invention.

### DETAILED DESCRIPTION OF THE PREFERRED EMBODIMENTS

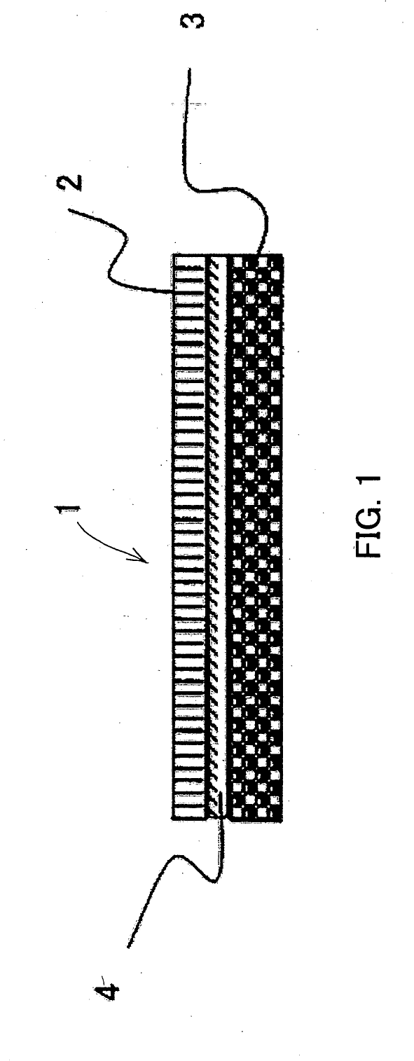

As shown in FIG. 1, the carpet 1 for use in vehicles according to the present invention includes an upper surface layer 2, a nonwoven fabric sound absorption layer 3, and an air permeable adhesive resin layer 4 made of thermoplastic resin which is formed by being extruded into filament-like resin pieces from an extruder and integrally secures the upper surface layer 2 and the sound absorption layer 3. The thickness direction air permeability of the entire carpet 1 is set so as to fall within the range of 1 to 50 cm³/cm²·second.

In the present invention, the thickness direction air permeability of the entire carpet 1 should be set so as to fall within the range of 1 to 50 cm³/cm²·second because of the following reasons. If the air permeability is less than 1 cm³/cm²·second, some of the noise entered into an inside space of a vehicle from the upper side thereof via the roof, windows, doors and the like will be bounced and returned to the inside space of the vehicle without being absorbed by the adhesive resin layer 4. Therefore, sufficient silence in the inside space of the vehicle cannot be secured. On the other hand, if the air permeability exceeds 50 cm³/cm²·second, in cases where the noise entering from the carpet-disposed floor is too large to be assuredly absorbed by the sound absorption layer, sufficient silence in the inside space of the vehicle cannot be secured because of the noise leaking into the inside space of the vehicle through the adhesive resin layer 4. Because of these reasons, in order to assuredly secure the silence under any conditions, the air permeability is limited to the aforementioned specific range.

The thermoplastic resin constituting the adhesive resin layer 4 is not limited to a specific one so long as it is thermoplastic. For example, polyolefine resin such as polyethylene, ethylene-vinylacetate copolymer (EVA resin) and polypropylene, and vinyl chloride resin can be exemplified. Among these resins, it is preferable to use polyolefine resin in view of adhesive strength and recycling. Among the polyolefine resin, the most preferable one is polyethylene having a cost-effective advantage.

The aforementioned upper surface layer 2 may have pile on the surface thereof or may not have pile on the surface thereof, and is not limited to a specific one. As the former examples, a tufted carpet, a woven carpet, a knitted carpet and an electrode position carpet can be exemplified. As the latter example, a needle punched nonwoven fabric can be exemplified. The material of the upper surface material layer 2 is not limited to a specific one, and can be constituted by synthetic fibers such as polyester fibers, polyamide fibers, polypropylene fibers or acrylic fibers or natural fibers such as hemp, cotton or wool.

The aforementioned nonwoven fabric sound absorption layer 3 is not limited to a specific one, and can be any nonwoven fabric. For example, a needle punched nonwoven fabric, a water needled nonwoven fabric, a spunbonded nonwoven fabric or a wool felt can be used. The kind of fiber constituting the nonwoven fabric sound absorption layer 3 is not limited to a specific one, and the layer can be constituted by synthetic fibers such as polyester fibers, polyamide fibers, polypropylene fibers, acrylic fibers, or natural fibers.

It is preferable that the thickness of the nonwoven fabric sound absorption layer 3 falls within the range of 1 to 15 mm because of the following reasons. If the thickness is less than 1 mm, sufficient sound absorption effects cannot be obtained. To the contrary, if the thickness exceeds 15 mm, the height of the inside space of the vehicle is reduced, which deteriorates the user's feeling of available room and also causes cost problems.

It is preferable that the apparent density of the nonwoven fabric sound absorption layer 3 falls within the range of 0.01 to 0.5 g/cm³ because of the following reasons. If it is less than 0.5 g/cm³, it is difficult to obtain sufficient sound absorption performance. To the contrary, if it exceeds 0.5 g/cm³, it is difficult to secure the lightweight performance as a carpet 1 for use in vehicles.

The fineness of the fiber constituting the nonwoven fabric sound absorption layer 3 preferably falls within the range of 0.1 to 30 dtex because of the following reasons. If it is less than 0.1 dtex, low frequency range noise is not effectively absorbed and the cushion property deteriorates. To the contrary, if it exceeds 30 dtex, high frequency range noise is not effectively absorbed. It is more preferable that the fineness of the fiber constituting the sound absorption layer 3 falls within the range of 0.1 to 15 dtex.

In the aforementioned embodiment, no layer is laminated on the lower surface of the nonwoven fabric sound absorption layer 3. However, the present invention is not limited to this structure. For example, a slip prevention resin layer (for example, a rubber family latex (SBR, etc.) coated layer) can be laminated on the lower surface of the nonwoven fabric sound absorption layer 3. In this case, however, the thickness direction air permeability of the entire carpet 1 should fall within the range of 1 to 50 cm³/cm²·second.

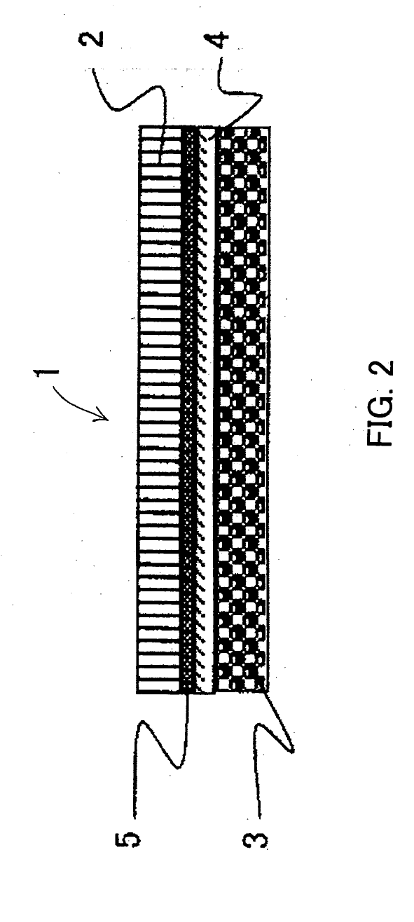

Furthermore, as shown in FIG. 2, a latex layer 5 or the like to prevent the pile from being pulled out can be provided on the lower surface of the upper surface layer 2. In other words, a latex layer 5 can be disposed between the upper surface layer 2 and the adhesive resin layer 4. In this case too, it is required to design such that the thickness direction air permeability of the entire carpet 1 falls within the range of 1 to 50 cm³/cm²·second.

Furthermore, to the upper surface layer 2 and/or the nonwoven fabric sound absorption layer 3, antistatic finish, mothproof finish, flame proof finish, soil resistant finish and/or odor elimination finish can be applied. In this case too, the thickness direction air permeability of the entire carpet 1 should be set to fall within the range of 1 to 50 cm³/cm²·second.

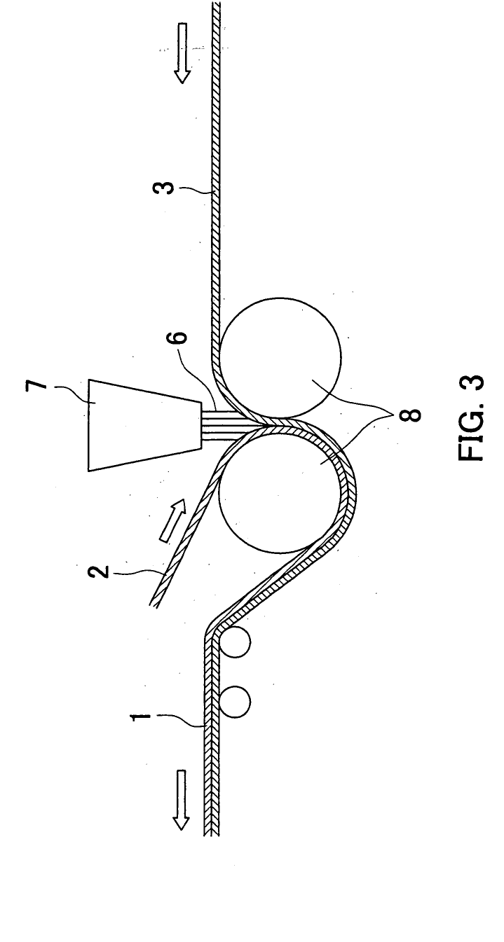

The carpet for use in vehicles according to the present invention can be, for example, manufactured as follows. As shown in FIG. 3, the upper surface layer 2 and the nonwoven sound absorption layer 3 are supplied constantly toward the T-die type extruder 7, and then superimposed between the nip roles 8 and 8. Immediately before they are superimposed, filament-like melted thermoplastic resin pieces 6 extruded from the T-die type extruder 7 are applied thereto. The extruded filament-like thermoplastic resin pieces 6 will form an air permeable adhesive resin layer 4 and integrally secure the upper surface layer 2 and the sound absorption layer 3 when these layers are pressured and cooled with the nip roles 8 and 8.

Although the filament-like resin pieces 6 can be applied linearly, it is preferable to apply the filament-like resin pieces 6 in a zigzag manner or in a crossed manner for the purpose of stabilizing the air permeability and enhancing the carpet strength. In order to do this, it is preferable that the filament-like adhesive resin pieces 6 are applied while moving right and left (i.e., in the direction parallel to the widthwise direction of the upper surface material which is being supplied continuously) by moving the T-die extruder 7 or the mouth piece thereof in the direction perpendicular to the traveling direction of the upper surface material (i.e., in the direction parallel to the widthwise direction of the upper surface material which is being supplied continuously) or supplying air flows against the filament-like thermoplastic resin pieces 6. The resin extruding openings of the extruder are preferably arranged in 1(one) to 5(five) rows along the traveling direction of the carpet (i.e., in the right and left direction in FIG. 3, in other words, in the direction of the arrow) (see FIG. 3. In FIG. 3, five rows are arranged). Furthermore, it is preferable that the opening size (diameter) is preferably 1 to 7 mm. Furthermore, it is preferable that the pitch of the extruding openings is 5 to 200 pieces/10 cm (5 to 200 pieces per 10 cm along the direction parallel to the widthwise direction of the upper surface material which is being supplied continuously).

It is preferable to employ cooling rolls as the nip rolls 8. In cases of applying pressure with cooling-and-pressurizing rolls, the forced cooling operation can be performed simultaneously with the lamination, which can facilitate the solidification of the melted thermoplastic resin, thus improving the workability.

In the aforementioned manufacturing method, it is preferable that the melt flow rate of the thermoplastic resin constituting the adhesive resin layer is 1 to 100 and that the applying amount of the thermoplastic resin is 50 to 500 g/m². If the melt flow rate is less than 1, it becomes difficult to evenly apply and attain the targeted air permeability of 1 to 50 cm³/cm²·second, and therefore it is not preferable. To the contrary, if the melt flow rate exceeds 100, the resin easily permeates the upper surface material layer 2 and the nonwoven fabric sound absorption layer 3, resulting in insufficient adhesive strength, and therefore it is not preferable. Furthermore, if the applying amount is less than 50 g/m², it is difficult to obtain sufficient adhesive strength, and therefore it is not preferable. To the contrary, if the applying amount exceeds 500 g/m², the air permeability becomes insufficient, and therefore it is difficult to secure the targeted air permeability of 1 to 50 cm³/cm²·second. Thus, it is not preferable in cost and workability.

Next, concrete embodiments of a carpet for use in vehicles according to the present invention will be explained. The carpet for use in vehicles and the manufacturing method thereof according to the present invention will not be limited to these embodiments.

<Materials>

Upper surface material A: Nonwoven fabric made of polyester fibers (the weight of unit area: 100 g/m²) with tufted pile made of nylon fibers (the pile weight of unit area: 500 g/m²)

Upper surface material B: Needle-punched nonwoven fabric (polyester fibers, the weight per unit area: 500 g/m²)

Sound absorption nonwoven fabric A: Needle-punched nonwoven fabric (the thickness: 4 mm, the apparent density: 0.1 g/cm³) made of polyester fibers (3.3 dtex /4.4 dtex=60 wt %/40 wt %)

Sound absorption nonwoven fabric B: Spunbonded nonwoven fabric (the thickness: 10 mm, the apparent density: 0.07 g/cm³) made of fibers in which the same amount of polyethylene fibers of 1.6 dtex and fiber-division type polyester fibers of 0.2 dtex are mixed

Sound absorption nonwoven fabric C: Needle-punched nonwoven fabric (the thickness: 2.5 mm, the apparent density: 0.03 g/cm³) made of polyester fibers (6.6 dtex /4.4 dtex=70 wt %/30 wt %)

Sound absorption nonwoven fabric D: Needle-punched nonwoven fabric (the thickness: 6 mm, the apparent density: 0.2 g/cm³) made of polyester fibers (3.3 dtex /4.4 dtex=60 wt %/40 wt %)

Thermoplastic resin A: Polyethylene resin (the melt flow rate value: 38)

Thermoplastic resin B: EVA resin (the melt flow rate value: 17)

Thermoplastic resin C: Polypropylene resin (the melt flow rate value: 8)

Resin extruding opening mouth A: the opening diameter: 5 mm, the pitch of openings: 10 pieces/10 cm, the number of rows of openings: 3

Resin extruding opening mouth B: the opening diameter: 3 mm, the pitch of openings: 13 pieces/10 cm, the number of rows of openings: 4

### EXAMPLE 1

As shown in FIG. 3, while transferring the upper surface material A at a constant rate with the pile side faced downward, the upper surface member is superimposed with the sound absorption nonwoven fabric A which is supplied from the direction opposite to the supplying direction of the upper surface material A. At the superimposing portion thereof, a number of filament-like thermoplastic resin pieces A extruded from the T-die type extruder 7 equipped with resin extruding opening mouth A were applied by 350 g/m². Immediately thereafter, they were pressurized and cooled with the nip rolls 8 and 8 to thereby obtain a carpet 1 for use in vehicles. The thickness direction air permeability of this carpet was 31 cm³/cm²·second.

### EXAMPLE 2

In the same manner as in Example 1 except for the conditions shown in Table 1, a carpet 1 for use in vehicles was obtained. The thickness direction air permeability of this carpet was 24 cm³/cm²·second.

### EXAMPLE 3

In the same manner as in Example 1 except for the conditions shown in Table 1, a carpet 1 for use in vehicles was obtained. The thickness direction air permeability of this carpet was 20 cm³/cm²·second.

### EXAMPLE 4

In the same manner as in Example 1 except for the conditions shown in Table 1, a carpet 1 for use in vehicles was obtained. The thickness direction air permeability of this carpet was 42 cm³/cm²·second.

### EXAMPLE 5

In the same manner as in Example 1 except for the conditions shown in Table 1, a carpet 1 for use in vehicles was obtained. The thickness direction air permeability of this carpet was 36 cm³/cm²·second.

TABLE 1

| | | | | Sound | | |
|---|---|---|---|---|---|---|
| | Upper | Thermo- | Applied | absorption | Resin | |
| | surface | plastic | amount | nonwoven | extruding | Air permeability |
| | member | resin | (g/m²) | fabric | mouth | (cm³/cm² · sec) |
| Example 1 | A | Thermo- | 350 | Nonwoven | A | 31 |
| | | plastic | | fabric A | | |
| | | resin A | | | | |
| Example 2 | B | Thermo- | 450 | Nonwoven | A | 24 |
| | | plastic | | fabric B | | |
| | | resin B | | | | |
| Example 3 | B | Thermo- | 500 | Nonwoven | A | 20 |
| | | plastic | | fabric B | | |
| | | resin C | | | | |
| Example 4 | A | Thermo- | 250 | Nonwoven | B | 42 |
| | | plastic | | fabric C | | |
| | | resin B | | | | |
| Example 5 | A | Thermo- | 300 | Nonwoven | B | 36 |
| | | plastic | | fabric D | | |
| | | resin A | | | | |
| Comp. | A | Thermo- | 45 | Nonwoven | B | 60 |
| Example 1 | | plastic | | fabric D | | |
| | | resin A | | | | |
| Comp. | A | PE | 400 | Nonwoven | | 0 |
| Example 2 | | hot-melt | | fabric A | | |
| | | film | | | | |
| Comp. | A | PE | 150 | Nonwoven | | 0.5 |
| Example 3 | | hot-melt | | fabric A | | |
| | | film | | | | |
| Comp. | A | PE | 30 | Nonwoven | | 45 |
| Example 4 | | mesh-like | | fabric A | | |
| | | film | | | | |

### COMPARATIVE EXAMPLE 1

In the same manner as in Example 1 except for the conditions shown in Table 1, a carpet 1 for use in vehicles was obtained. The thickness direction air permeability of this carpet was 60 cm³/cm²·second.

### COMPARATIVE EXAMPLE 2

The aforementioned upper surface member A was disposed with the pile side faced upwardly. A polyethylene hot-melt film of 400 g/m² and the sound absorption nonwoven fabric A were disposed on the upper surface material in this order and then heated in this laminated state to thereby obtain a carpet for use in vehicles. The thickness direction air permeability of this carpet was 0 cm³/cm²·second.

### COMPARATIVE EXAMPLE 3

A carpet for use in vehicles was obtained in the same manner as the comparative example 1 except that a polyethylene hot-melt film of 150 g/m²was used in place of the polyethylene hot-melt film of 400 g/m². The thickness direction air permeability of this carpet was 0.5 cm³/cm²·second.

### COMPARATIVE EXAMPLE 4

A carpet for use in vehicles was obtained in the same manner as the Comparative Example 1 except that a net-shaped sheet made of polyester (30 g/m²) was used in place of the polyethylene hot-melt film. The thickness direction air permeability of this carpet was 45 cm³/cm²·second.

In each of the carpets obtained as mentioned above, the sound absorption property and the adhesive-strength were investigated based on the following evaluation methods. The results are shown in Table 2.

<Sound Absorption Property Evaluation Method>

Sound absorption rate was measured based on the perpendicular incidence sound absorption measuring method of ASTEM E1050.

<Silence Evaluation Method>

The evaluation of the aforementioned sound absorption property is shown as“⊚” in which both the sound absorption property at 1000 Hz and 2000 Hz was 0.1 or more and either of them was 0.3 or more, “◯” in which both the sound absorption property at 1000 Hz and 2000 Hz was not smaller than 0.1 but less than 0.3, both of which are acceptable, and “×38 in which either of them was less than 0.1, which is not acceptable.

<Adhesive Strength Evaluation Method>

In this evaluation, “◯” denotes that the adhesive strength between the upper surface layer and the nonwoven sound absorption layer was 50 N or more, “Δ” denotes that the adhesive strength was not less than 20 N but less than 50N, and “×” denotes that the adhesive strength was less than 20 N.

TABLE 2

| | Sound absorption rate | | | Adhesive |
|---|---|---|---|---|
| | 1000 Hz | 2000 Hz | Silence | strength |
| Example 1 | 0.15 | 0.30 | ⊚ | ◯ |
| Example 2 | 0.10 | 0.21 | ◯ | ◯ |
| Example 3 | 0.10 | 0.23 | ◯ | ◯ |
| Example 4 | 0.13 | 0.26 | ◯ | ◯ |
| Example 5 | 0.17 | 0.41 | ⊚ | ◯ |
| Comparative | 0.07 | 0.10 | X | X |
| Example 1 | | | | |
| Comparative | 0.04 | 0.07 | X | ◯ |
| Example 2 | | | | |
| Comparative | 0.05 | 0.08 | X | ◯ |
| Example 3 | | | | |
| Comparative | 0.12 | 0.23 | ◯ | X |
| Example 4 | | | | |

As will be apparent from Table 2, in the carpets according to Examples 1 to 5 of the present invention, the upper surface layer and the nonwoven fabric sound absorption layer were secured with sufficient adhesive strength, and the carpets were excellent in sound absorption properties and capable of obtaining sufficient silence.

To the contrary, in Comparative Example 1, it was not possible to secure air permeability and therefore silence property could not be obtained. In Comparative Example 3, although an air permeability falling within the range from 1 to 50 cm³/cm²·second could be attained and enough silence could be obtained, the adhesive strength was inadequate, and therefore it was not possible to use it as a carpet. In Comparative Example 4, the adhesive strength was not enough and the adhesive durability was poor.

As explained above, the carpet for use in vehicles according to the present invention, excellent sound absorption can be attained, and therefore it is possible to keep silence in a space of a vehicle.

Furthermore, in cases where the thickness of the sound absorption layer falls within the range of 1 to 15 mm, the apparent density of the layer falls within the range of 0.01 to 0.5 g/m³ and the fineness of the fiber constituting the sound absorption layer falls within the range of 0.1 to 30 dtex, sufficient sound absorption performance can be given at a broad frequency range covering from a lower frequency to a higher frequency.

In cases where polyolefine resin is used as the thermoplastic resin, durability and recycling can be enhanced.

According to the manufacturing method of the present invention, by simply attach a mouth piece for extruding melted resin into filament-like pieces to the resin extruding opening of an extruder, it is possible to obtain an adhesive resin layer having air permeability without deteriorating workability. The carpet can be manufactured at a normal manufacturing efficiency.

It should be appreciated that the terms and descriptions herein are not used for limiting the scope of the invention, but used only for explanatory purposes, and the invention does not eliminate any feature equivalent to the feature disclosed and explained herein, and permits any modifications and substitutions within the scope of the present invention defined by the appended claims.

1. A carpet for use in vehicles, comprising an upper surface layer, a sound absorption layer made of nonwoven fabric and an adhesive resin layer integrally securing the upper surface layer and the sound absorption layer, wherein the adhesive resin layer is an air permeable resin layer formed by extruding melted thermoplastic resin into filament-like pieces by an extruder, and wherein a thickness direction air permeability of the carpet falls within the range of 1 to 50 cm³/cm²·second.

2. The carpet for use in vehicles according to claim 1, wherein the thickness direction air permeability of the carpet is 10 to 45 cm³/cm²·second.

3. The carpet for use in vehicles according to claim 1, wherein the thickness direction air permeability of the carpet is 25 to 40 cm³/cm²·second.

4. The carpet for use in vehicles according to claim 1, wherein a thickness of the sound absorption layer is 1 to 15 mm.

5. The carpet for use in vehicles according to claim 1, wherein an apparent density of the sound absorption layer is 0.01 to 0.5 g/cm³.

6. The carpet for use in vehicles according to claim 1, wherein a fineness of the filament-like piece constituting the sound absorption layer falls within the range of 0.1 to 30 dtex.

7. The carpet for use in vehicles according to claim 1, wherein a fineness of the filament-like piece constituting the sound absorption layer falls within the range of 0.1 to 15 dtex.

8. The carpet for use in vehicles according to claim 1, wherein a thickness of the sound absorption layer is 1 to 15 mm, wherein an apparent density of the sound absorption layer is 0.01 to 0.5 g/cm³, and wherein a fineness of the filament-like piece constituting the sound absorption layer falls within the range of 0.1 to 30 dtex.

9. The carpet for use in vehicles according to claim 1, wherein the thermoplastic resin constituting the adhesive resin layer is polyolefin resin.

10. The carpet for use in vehicles according to claim 1, wherein the thermoplastic resin the constituting the adhesive resin layer is polyethylene.

11. The carpet for use in vehicles according to claim 1, wherein a melt flow rate of the thermoplastic resin constituting the adhesive resin layer is 1 to 100.

12. The carpet for use in vehicles according to claim 1, wherein a melt flow rate of the thermoplastic resin constituting the adhesive resin layer is 10 to 50.

13. The carpet for use in vehicles according to claim 1, wherein an adhered amount of the thermoplastic resin constituting the adhesive resin layer is 50 to 500 g/m².

14. The carpet for use in vehicles according to claim 1, wherein an adhered amount of the thermoplastic resin constituting the adhesive resin layer is 100 to 300 g/m².

15. The carpet for use in vehicles according to claim 1, wherein a melt flow rate of the thermoplastic resin constituting the adhesive resin layer is 1 to 100, and wherein an adhered amount of the thermoplastic resin constituting the adhesive resin layer is 50 to 500 g/m².

16. The carpet for use in vehicles according to claim 1, wherein a melt flow rate of the thermoplastic resin constituting the adhesive resin layer is 10 to 50, and wherein an adhered amount of the thermoplastic resin constituting the adhesive resin layer is 100 to 300 g/m².

17. The carpet for use in vehicles according to claim 1, wherein the thickness direction air permeability of the carpet is 10 to 45 cm³/cm²·second, wherein a thickness of the nonwoven sound absorption layer is 1 to 15 mm, wherein an apparent density of the sound absorption layer is 0.01 to 0.5 g/cm³, wherein a fineness of the filament-like piece constituting the sound absorption layer falls within the range of 0.1 to 15 dtex, wherein a melt flow rate of the thermoplastic resin constituting the adhesive resin layer is 1 to 100, and wherein an adhered amount of the thermoplastic resin constituting the adhesive resin layer is 50 to 100 g/m².

18. The carpet for use in vehicles according to claim 1, wherein the carpet is a floor carpet for use in automobiles.

19. A method for manufacturing a carpet for use in vehicles, the method comprising:
extruding melted thermoplastic resin into filament-like resin pieces by an extruder; and
integrally securing an upper surface material and a nonwoven fabric via an air permeable resin layer by superimposing the upper surface material and the nonwoven fabric via the filament-like resin pieces.

20. A method for manufacturing a carpet for use in vehicles, the method comprising:
continuously extruding melted thermoplastic resin into filament-like resin pieces by an extruder; and
integrally securing an upper surface material and a nonwoven fabric via an air permeable resin layer by superimposing the upper surface material and the nonwoven fabric which are being supplied continuously via the filament-like resin pieces.

21. The method for manufacturing a carpet for use in vehicles according to claim 20, wherein the melted thermoplastic resin is continuously extruded into filament-like resin pieces in a vertically downward direction or in an approximately vertically downward direction by the extruder.

22. A method for manufacturing a carpet for use in vehicles, the method comprising:
continuously extruding melted thermoplastic resin into filament-like resin pieces in a vertically downward direction or in an approximately vertically downward direction by an extruder; and
integrally securing an upper surface material and a nonwoven fabric via an air permeable resin layer by superimposing the upper surface material and the nonwoven fabric immediately after supplying the filament-like resin pieces onto at least one of superimposing surfaces of the upper surface material and the nonwoven fabric which are being supplied continuously.

23. The method for manufacturing a carpet for use in vehicles according to claim 19, wherein the upper surface material and the nonwoven fabric are superimposed while being pressurized.

24. The method for manufacturing a carpet for use in vehicles according to claim 19, wherein the upper surface material and the nonwoven fabric are superimposed while being pressurized and cooled.

25. The method for manufacturing a carpet for use in vehicles according to claim 23, wherein the pressurizing is performed by using cooling pressure rollers.

26. The method for manufacturing a carpet for use in vehicles according to claim 25, wherein a cooling pressure rollers are of a water-cooling type.

27. The method for manufacturing a carpet for use in vehicles according to claim 19, wherein the extruder is a T-die type extruder.

28. The method for manufacturing a carpet for use in vehicles according to claim 19, wherein a thickness of the extruded filament-like resin piece is 0.5 to 7 mm in diameter.

29. The method for manufacturing a carpet for use in vehicles according to claim 19, wherein a displacement density of the extruded filament-like resin pieces is 5 to 200 pieces/10 cm (i.e., 5 to 200 pieces per 10 cm in a direction parallel to a widthwise direction of the upper surface material which is being continuously supplied).

30. The method for manufacturing a carpet for use in vehicles according to claim 19, wherein a melt flow rate of the thermoplastic resin is 1 to 100, and wherein weight per unit area of the permeable resin layer is 50 to 500 g/m².

31. The method for manufacturing a carpet for use in vehicles according to claim 19, wherein a melt flow rate of the thermoplastic resin is 10 to 50, and wherein weight per unit area of the permeable thermoplastic resin layer is 100 to 300 g/m².

32. The method for manufacturing a carpet for use in vehicles according to claim 22, wherein the filament-like resin pieces are applied while moving the filament-like resin pieces in a direction parallel to a widthwise direction of the upper surface material which is being continuously supplied, and wherein “in a direction parallel to a widthwise direction of the upper surface material which is being continuously supplied” denotes a depth direction in FIG. 3.

33. The method for manufacturing a carpet for use in vehicles according to claim 32, wherein the filament-like resin pieces are proved in a direction parallel to a widthwise direction of the upper surface material which is being continuously supplied by moving the extruder in a direction parallel to the widthwise direction of the upper surface material which is being continuously supplied.

34. The method for manufacturing a carpet for use in vehicles according to claim 32, wherein the filament-like resin pieces are moved in a direction parallel to a widthwise direction of the upper surface material which is being continuously supplied by applying air flow to the filament-like resin pieces.

35. The method for manufacturing a carpet for use in vehicles according to claim 22, wherein the filament-like resin pieces are applied to both of the superimposing surfaces of the upper surface material and the nonwoven fabric which are being supplied.

36. A method for manufacturing a carpet for use in vehicles, the method comprising:
continuously extruding melted thermoplastic resin having melt flow rate of 1 to 100 into plural rows of filament-like resin pieces each having a thickness (diameter) of 0.5 to 7 mm in a vertically downward direction or in an approximately vertically downward direction by a T-die type extruder; and
integrally securing an upper surface material and a nonwoven fabric via an air permeable resin layer by superimposing the upper surface material and the nonwoven fabric in a pressurized cooling state immediately after supplying the filament-like resin pieces at a supplying amount of 50 to 500 g/m² onto each of the superimposing surfaces of the upper surface material and the nonwoven fabric which are being supplied continuously while moving the filament-like resin pieces in a direction parallel to a widthwise direction of the upper surface material and the nonwoven fabric which are being supplied continuously.

37. The method for manufacturing a carpet for use in vehicles according to claim 36, wherein displacement density of the extruded filament-like resin pieces is 5 to 200 pieces/10 cm.
